(19) United States
(12) Patent Application Publication
(10) Pub. No.: US 2008/0215362 A1
(43) Pub. Date: Sep. 4, 2008

(54) METHOD AND APPARATUS OF ASSESSING NEED FOR HEALTH CARE AND FACILITATING THE PROVISION OF HEALTH CARE

(76) Inventors: Darrel M. Powell, Cincinnati, OH (US); James W. Voegele, Cincinnati, OH (US); Michael A. Murray, Bellevue, KY (US); Jill F. Schiaparelli, Mason, OH (US)

Correspondence Address: PHILIP S. JOHNSON;JOHNSON & JOHNSON, ONE JOHNSON & JOHNSON PLAZA, NEW BRUNSWICK, NJ, 08933-7003, US

(21) Appl. No.: 11/939,652

(22) Filed: Nov. 14, 2007

Related U.S. Application Data
(60) Provisional application No. 60/865,686, filed on Nov. 14, 2006.

(51) Int. Cl. G06Q 10/00

(52) U.S. Cl. 705/2

(57) ABSTRACT

A health care assessment system and associated methods are provided for providing increased access to individuals for assessing whether a need exists for health care and then also facilitating an individual's access to health care as needed. Embodiments of the system include a health care assessment system for receiving input from a patient and generating an output reflecting an indivdual's risk of one or more disease states. The health care assessment system is further capable of providing resources for health care and visual tools for collecting patient history.

### REFERENCE TO RELATED APPLICATIONS

This application claims the benefit of U.S. Provisional Application Ser. No. 60/865,686 entitled “METHOD AND APPARATUS OF ASSESSING NEED FOR HEALTH CARE AND FACILTATING THE PROVISION OF HEALTH CARE” to Darrel M. Powell et al., filed 14 Nov. 2006.

### FIELD OF THE INVENTION

The present invention relates generally to an apparatus and method for assessing a consumer's need for health care. More particularly, this invention relates to a system and method for determining an individual's risk of one or more disease states and further facilitating access to health care for the individual as it relates the individual's risk of one or more disease states.

### BACKGROUND OF THE INVENTION

Throughout the world, people are struggling with their weight. At present, more than 1 billion people worldwide are either overweight or obese. The statistics on the impact to health, economics, productivity and quality of life are well documented and staggering.

While numerous prevention methods and approaches are being advocated, the reality is that in the United States more than ⅔ of people cannot maintain a healthy weight and progress into the categories of overweight and obese. And, shockingly, this number continues to increase year after year with no sign of abatement within sight.

Excess weight has been documented to increase the prevalence of more than 25 medical conditions such as Type II diabetes, hypertension and coronary artery disease. This combination of factors means that weight challenged individuals are more costly to our health care system and result in substantial decrease in quality life. In addition, while there are numerous treatment modalities available for weight challenged individuals—from self-directed and consumer program to more advanced medical and surgical treatments—a disproportionate number of the weight challenged population opt not to seek any treatment.

By examining the path consumers follow in their journey to a healthy weight, it became apparent that substantial numbers of overweight and obese people were not seeking care.

The flow of consumers through an obesity care pathway is illustrated in FIGS. 1 and 2. Of the 1 billion people classified as either overweight or obese by the World Health Organization, just 60 million progress into the category of seeking an intervention for their weight issues.

There are multiple factors that drive this including personal denial, lack of awareness of the health risks of obesity and confusion on the part of both consumers and health care providers about appropriate treatment options.

At present, the most commonly accepted measure of obesity is Body Mass Index (BMI), which is a ratio of an individual's weight to height. While this measure does categorize individuals in terms of the severity of their obesity, it is a poor indicator of the health risk of an individual. Factors that contribute to the health risks include location and distribution of body fat, genetic predisposition to co-morbid condition and lifestyle considerations. Unfortunately, little research has been done to understand which methods of weight loss are most appropriate for a specific patient. The BMI approach does not account for any of the lifestyle, emotional or situational factors driving an individual's obesity.

As a result, BMI does not allow patients to react to the urgency of their own situation. Psychologically, many individuals dismiss the BMI as being “not applicable to them” and others believe that the charts were developed for people with different ethnic heritage.

Further, the current battery of questions typically asked of a candidate for any type of weight loss approach focus more on amount of excess weight and do not take into account the “whole person”—physically, psychologically and environmentally.

In addition, it is imperative in any good holistic treatment approach for the clinician to develop an understanding of the multiple factors that drive a person's unique obesity and the reasons why the individual may have failed certain types of intervention in the past or why the person has not sought any intervention at all.

Further, while most health care providers are familiar with the BMI measurement, there are no widely acceptable treatment protocols for them to follow.

It would be desirable to provide a health care assessment system as described herein to overcomes those deficiencies.

### BRIEF SUMMARY OF THE INVENTION

The present invention relates to methods and apparatus for providing increased access to individuals for assessing whether a need exists for health care and then also facilitating an individual's access to health care as needed. The invention will be described in terms obesity as an example only, however, the invention is equally applicable to other disease states.

As an example, the present invention relates to methods and apparatus useful to compel more of the 1 billion people to enter the obesity care pathway. The invention is capable of delivering information and advice to patients (i.e. the consumers), and it is also structured to provide benefits to other stakeholders such as payers, employers and clinicians.

One advantage of the invention is to: provide awareness and education to the consumer; provide the consumer with a measure of their health risks as a result of their obesity (for example, Type II Diabetes, Hypertension and Coronary Artery Disease) based on a combination of inputs which could include physical measurements (for example, waist circumference, waist hip ration, bioimpedence or base metabolic rate), lifestyle considerations, current health concerns and genetic history; provide the consumer with a recommendation for consultations with specific medical professionals who could address weight loss options and treatment of specific co-morbidities;— provide information and data for physicians to recommend specific treatment and follow up plans; provide information and data (aggregate or individual) to payers and employers to help identify and intervene for “at risk” populations; and help a patient track their progress during a weight loss journey.

A first expression of a first embodiment of the invention is a health assessment system comprising a series of questions, which answers to the questions can form the basis of determining an individual's risk of any number of diseases. Because, in different portions of the population, different independent variables better determine the risk level of various disease states or anomalies, the system makes a decision based on the individual's specific inputs which independent variables to use in estimating risk of anomalies. For example, among Australian women, the ratio of the measurements of the waist to hip correlates to incidence of dyslipidaemia, but such ratio does not correlate the same disease in Australian men. As further example, body mass index correlates differently in studies to incidence of hypertension, dyslipidemia, and diabetes in Japanese than it does in an American population. A lower body mass index indicates a more increased risk of disease in Japanese individuals than in Americans.

An example of inputs in the form of questions, or measured anthropomorphic data include: height, weight, waist circumference, hip circumference, thigh circumference, thorax circumference, caloric intake, bioelectrical impedance, gender, neck circumference, fasting glucose, lean body mass, age, gender, ethnicity, pre or post menopausal, incidence of gallstones, hormone replacement use, oral contraceptive use, intrabdominal fat area, position of intrabdominal fat area, history of smoking, history of drinking, history of cholesterol level. The system analyzes the inputs and calculates certain body characteristics, such as: body mass index (BMI), waist to hip ratio, waist to height ratio and waist to thigh ratio. Reference is made to “Waist circumference, waist-hip ratio and body mass index and their correlation with cardiovascular disease risk factors in Australian adults” by Dalton et al, Journal of Internal Medicine 2003: 254; 555-563.

The system then determines, based on factors such as age, ethnicity, gender, body mass index, or ratios, which factors to determine risks for which disease or anomaly. For example, some studies show that the body measurement ratios become better predictors than body mass index for individuals with lower body mass indices.

The system may then provide an output the estimated risk increase, for example, disease states such as: Diabetes, Hypertension, Dyslipidemia, Low HDL, Cardio-vascular disease, Prostate cancer, Breast cancer, Sleep apnea, Melanoma, Colon cancer, Benign prostatic hypertrophy, Asthma, Lymphoma and Multiple myeloma.

In a first expression of a second embodiment the invention considers the presence or absence of one or more of several risk factors, the system can group risks of several anomalies and report the risk of having at least one of several. The system could further estimate a secondary risk, for example, of coronary heart disease based on the estimated risk of hypertension. The risk of hypertension could be based on a measured or reported independent variable or input.

The input measurements of anthropomorphic data can take the form of a questionnaire, or simple measurements with a tape. The input measurements could also be based from computerized scans such as magnetic resonance images or imaging body scans that generate 3-D images. A change in risk can be calculated based on predicted changes in body measurements that would occur if the subject person engaged in prescribed behaviors such as exercise, diet changes, or recommended surgery.

### BRIEF DESCRIPTION OF THE FIGURES

The novel features of the invention are set forth with particularity in the appended claims. The invention itself, however, both as to organization and methods of operation, may best be understood by reference to the following description, taken in conjunction with the accompanying drawings in which:

FIG. 1 is a graphical representation of an obesity care pathway;

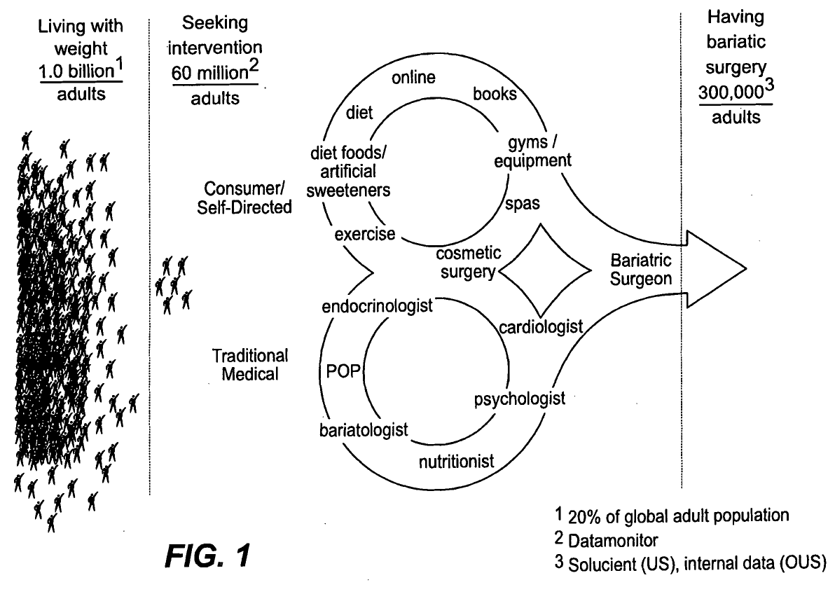

FIG. 2 is a flow chart illustrating a patient care pathway;

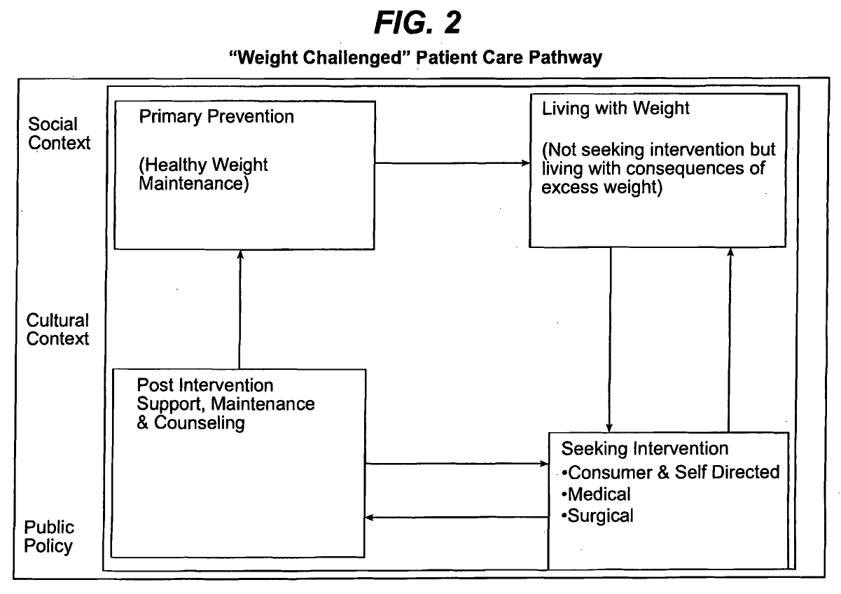

FIG. 3 is a flow chart illustrating the patient care pathway including the additional process step of one embodiment of the present invention;

FIG. 4 is a general flow chart illustrating the steps of one embodiment of the invention;

FIG. 5 is a process map illustrating a first expression of the first embodiment of the present invention;

FIG. 6 is a process map illustrating a second embodiment of the present invention;

FIG. 7 is an algorithm or scorecard illustrating an example of certain individual parameters as they relate to a disease state; and

FIG. 8 is a graphical representation of a visual tool in accordance with one aspect of the invention.

### DETAILED DESCRIPTION OF THE INVENTION

Before explaining the present invention in detail, it should be noted that the invention is not limited in its application or use to the details of construction and arrangement of parts illustrated in the accompanying drawings and description. The illustrative embodiments of the invention may be implemented or incorporated in other embodiments, variations and modifications, and may be practiced or carried out in various ways. Further, unless otherwise indicated, the terms and expressions employed herein have been chosen for the purpose of describing the illustrative embodiments of the present invention for the convenience of the reader and are not for the purpose of limiting the invention.

Further, it is understood that any one or more of the following-described embodiments, expressions of embodiments, examples, etc. can be combined with any one or more of the other following-described embodiments, expressions of embodiments, examples, etc.

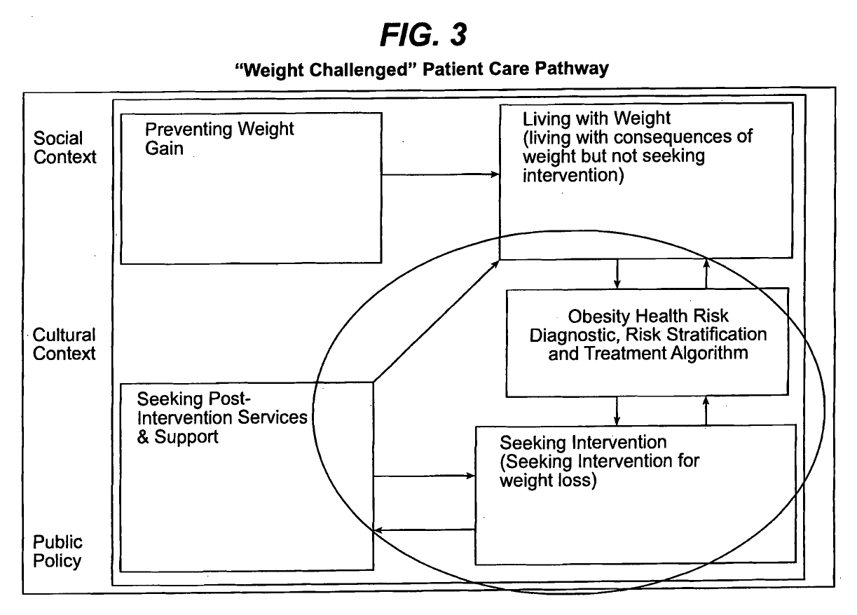

Referring now to FIG. 3, a large percentage of the population “lives with weight.” The population has increased weight and associated comorbidities and either does not realize the problem or ignores it. Many of these people can be helped if they were to have an awareness of the increased risk of comorbidities and are informed of a care path to take to reduce weight as shown in the box “Obesity Health Risk Diagnostic, Risk Stratification and Treatment Algorithm”. The increase in risk of a comorbidity is dependant upon many anthropomorphic factors, including height, weight, waist circumference, hip circumference, age, menopausal state, and others.

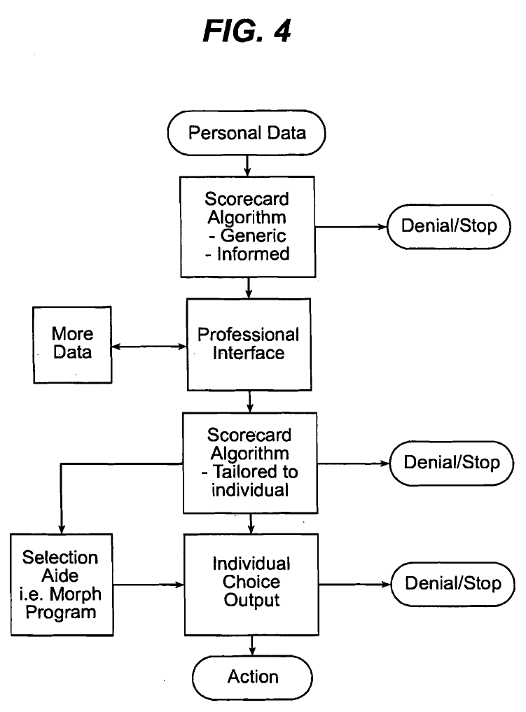

Referring now to FIG. 4, the present invention contemplates a method of collecting data from a participant, deciding upon an algorithm to use based upon the data collected, determining a risk of a comorbidity based on the anthropomorphic data collected, and giving the participant information on the risk and risk mitigation tailored to the measured data of the participant. The invention further contemplates a computerized device having programmed algorithms selectable based on input data.

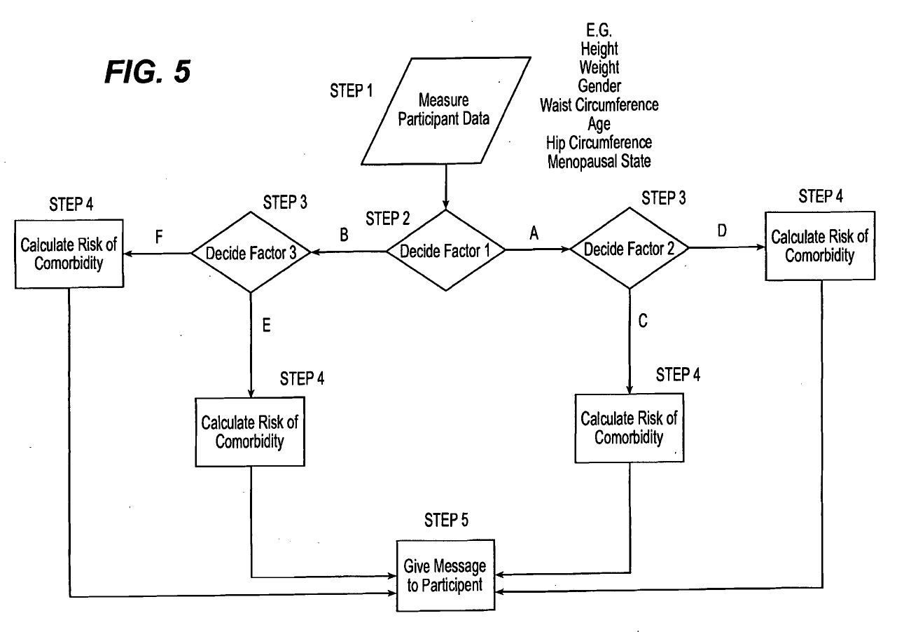

Referring now to FIG. 5 a first expression of the first embodiment of a health care assessment system includes step one, measuring participant health data, including for example, anthropomorphic data, physiological data, family history, health history and prescription drug use. The data can be measured by many means including requesting input into a programmable, microprocessor-based electronic controller, or by having technicians weigh and measure the participant, or by having measurement devices attached to an electronic controller. The electronic controller may be located in a medical professional setting, such as a hospital, physician's office, medical center, or in a retail setting, such as a pharmacy, mall, or health clinic or alternatively in the home.

Such measurement devices could be, for example, white light devices that create a computer scan, or more simple devices such as scales and tape measures. Step one could also include input on the psychological state of the participant, such as the participant's emotional state or previous experiences the participant has had while trying to change or reduce an anthropomorphic characteristic such as weight. Step one could also include collection of information about the participant's insurance program and health care providers in the program.

After inputs are entered the electronic controller determines an algorithm to perform an analysis, Step two. After the data are recorded, decisions can be made based on one or more bits of the data. In FIG. 5, determining a factor to be “A” takes one to a different decision point than determining a factor to be “B.” For example, risks of comorbidity as a function of measured data may differ because of the gender of the participant. Therefore, the factors “A” and “B” could be “male” and “female”. Females show an increased risk of hypertension at a lower waist to hip circumference ratio, for example, necessitating a different algorithm.

If necessary, the algorithm may be expanded based on another piece of anthropomorphic data, Step three. For example, if in Step two the participant is female, the electronic controller could further decide to choose different algorithms based on the ethnicity of the participant or the height of the participant. Although two branches are shown at each point, more branches are possible for decisions based on factors having more than two values. Ethnicity could be Asian, Asian Indian, or North American Caucasian, for example.

Step four calculates the risk of the participant. In the example provided, waist to hip circumference ratio is divided into three ranges and an estimated risk of diabetes, hypertension, and dyslipidaemia are calculated based on collected clinical data. With increased clinical knowledge and research, the calculation of step four could be further refined to include a continuous function, rather than a step-wise function based on ranges. Step four can calculate current risk of comorbid disease, and, if information from longitudinal clinical studies becomes available, can calculate the risk of developing the disease in the future.

In Step five the electronic controller issues a message to the participant based on the data collected and the calculation of the algorithm as exemplified below.

“Dear Mr. Smith, as a result of your body scan and the information you have provided, we estimate your health risks as follows:
You have a 50-70% chance of developing Type II Diabetes within the next 12 months.
You have a 40-60% chance of a major coronary event within the next 12 months.
You have a 20-40% chance of developing hypertension within the next 12 months.
You have a ______% chance of developing ______ within the next 12 months.”

The message can be the participant's risk of disease, i.e., a statement of the probability of having a current comorbid disease state. The message can be an increase of the probability of having a current comorbid disease state, i.e., a multiple of the probability of having a current comorbid disease state over the probability of a person within a normal range of a measured anthropomorphic factor having the disease state. The statement can be, for example, issued on a computer printout, delivered by a technician, or displayed on a computer screen.

The statement in step five can also include a care pathway for medical assistance in reducing the risk as exemplified below.

“As a result of the insurance and geographic information you provided, we recommended that you see the following health care providers:
Endocrinologist: Dr. Sugar, 123 Main Street, Anywhere Phone 55555555
Cardiologist: Dr. Heart, 234 Main Street, Anywhere Phone 555555
Primary Care Doctor: Dr. Fixit, 345 Main Street, Anywhere Phone 55555
Bariatric Surgery: Dr. Health, 456 Main Street, Anywhere Phone 55555”

The statement can therefore include names, addresses, phone numbers, e-mail address, and other information about doctors in the participant's health plan available to assist the participant. The statement can include health care centers for exercise and nutrition. The statement could also be tailored to the participant's input regarding psychological state or previous experiences related to weight or other anthropomorphic factor.

In an second expression of the first embodiment, the electronic controller may further schedule appointments for the participant for each of the health care provides as exemplified below:

“At your request we have scheduled the following appointments with the health care providers below that we recommend that you see:
Endocrinologist: Date, Time, Dr. Sugar, 123 Main Street, Anywhere Phone 55555555
Cardiologist: Date, Time, Dr. Heart, 234 Main Street, Anywhere Phone 555555
Primary Care Doctor: Date, Time, Dr. Fixit, 345 Main Street, Anywhere Phone
Bariatric Surgery: Date, Time, Dr. Health, 456 Main Street, Anywhere Phone 55555”

In a third expression of the first embodiment, the health assessment system provides information, such as educational literature or summaries of findings related to the identified disease states.

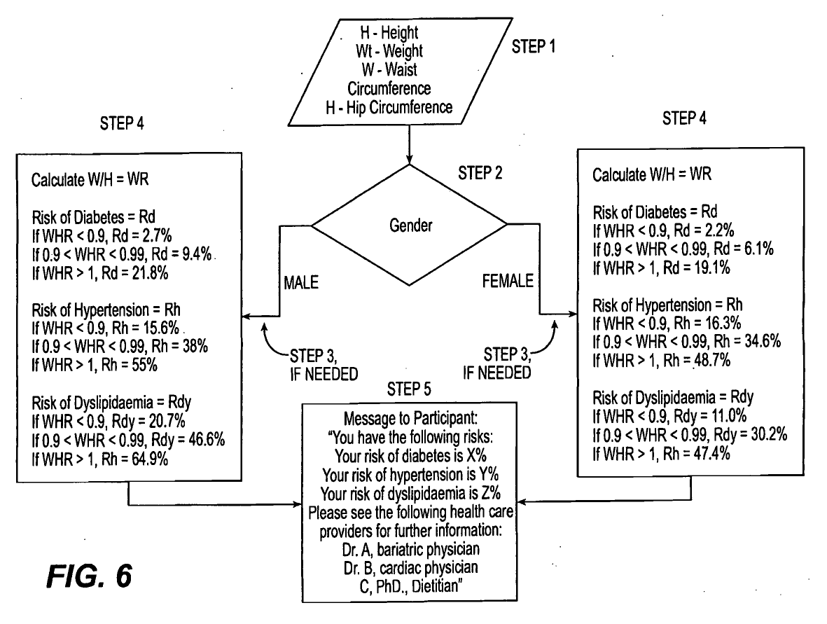

Referring now to FIG. 6 a second embodiment of the invention includes collecting information about waist circumference, hip circumference, and gender by any of various means, step one. Psychological information about the participant's state of well-being and previous experience the participant has had concerning weight can also be collected.

Step 2 requires a decision about the algorithm to be used based on the participant's gender. Step 3 (not shown) could require further choice of refinement of algorithm based on another factor or set of factors as previously discussed. If, for example, the participant has a certain height or is from a certain part of the world, a different algorithm may be required because of a different body response because of height or different dietary or lifestyle habits in various parts of the world. Refinement is limited only by the expertise of clinical researchers. Certain genetic markers could be envisioned as a determining factor, as further example.

In the next step, Step 4 for purposes of the example, the waist to hip circumference ratio (WHR) is calculated. Percentage probabilities of the existence of diabetes, of hypertension, and of dyslipidaemia are calculated based upon existing clinical data and the range. In the clinical data used for the example, the percentages are calculated as a stepwise continuous function with a constant percentage risk for each range of waist to hip circumference. Alternately, the waist to hip circumference ratio could be calculated earlier before selection of the algorithm based on gender.

In step 4, other anthropomorphic factors can also be used to calculate the probability of comorbidity, for example, body mass index (BMI) can be used. Waist circumference alone can be used. The factor can be selected in Step 3 based on a measured factor. For example, a woman from Asia may have more accurate prediction of a comorbidity by BMI, while prediction of a comorbidity for a man from North America may be more accurate if waist hip circumference is used.

In step 5, information is imparted to the participant. A woman who has a waist-hip circumference ratio of 0.83 could receive a message that she has a risk of diabetes of 6.1%, a risk of hypertension of 34.6%, and a risk of dislipidaemia of 30.2%. She could also receive notice of doctors in her healthcare plan and nutritional advice. She can receive information based on her psychological input, for example, if she has in the past tried much exercise and did not try diet, nutritionists could be suggested. The information could be in the form of further questions to explore the best next steps the participant could take along a care path. Thus, further interview of the participant can take place in step 5 to determine the best care path for the participant.

The risk could be characterized as a multiple of the risk that a person within the normal of the chosen anthropomorphic factor faces. Thus, a woman in the upper quartile of waist to hip ratio faces a greater than 10 times the risk of a woman in the lower quartile, or normal range, of risk of diabetes. Such a multiple could be reported to the participant, and the participant advised of steps for action.

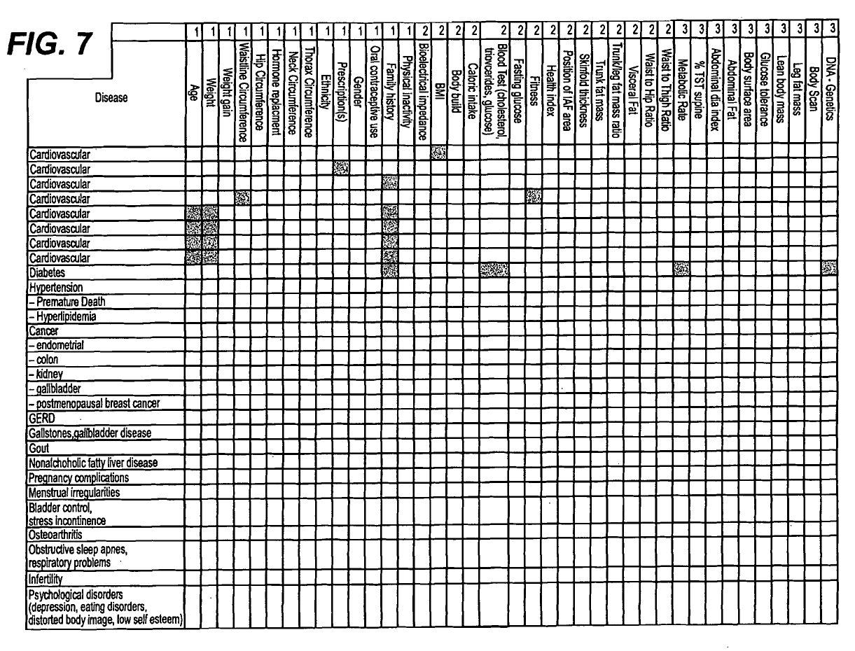

FIG. 7 is an example of an individual's scorecard as it relates to certain disease states.

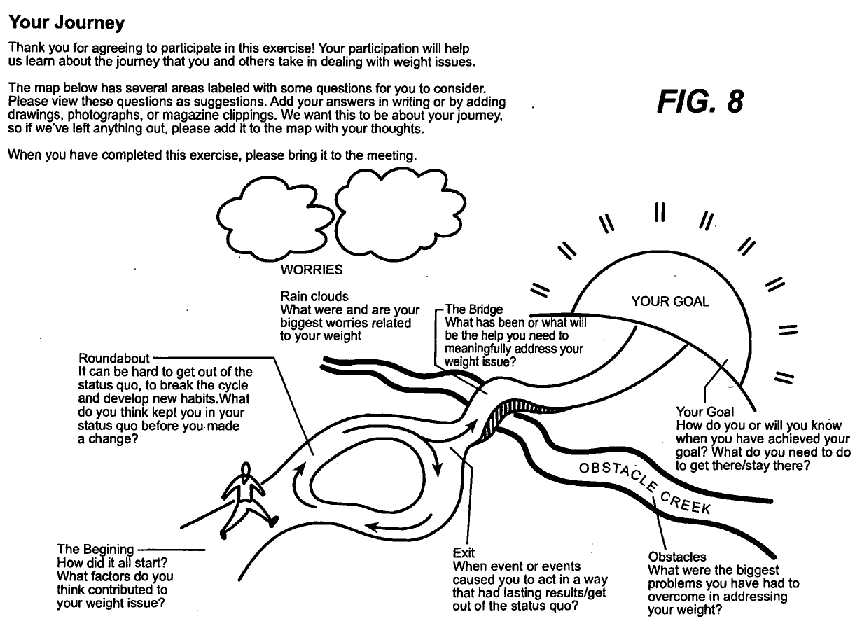

Referring now to FIG. 8, another aspect of the invention for facilitating health care contemplates a visual tool that offers a weight challenged patient a way to tell the story of their personal journey to healthy weight starting from the beginning of their weight challenges through the present day. This can be used as tool to determine an individualized treatment plan for a patient or can be used to track and assess the patient's progress on their journey.

Each weight challenged patient has had a unique and personal journey. FIG. 8 discloses an example of a Journey Map that is a simple but effective visual tool that will cause the patient to highlight key aspects of their journey. This, in turn, can give the patient, the clinician and market researchers insight into the patterns and drivers of the patients weight challenges.

Journey Maps can be used by Clinicians to learn more about their patients, in individual or in group settings, during an initial encounter or they can be used periodically through the patient's treatment to track progress. Journey Maps can also be used by Market Researchers to collect the pure voice of the consumer.

Preferably, a Journey Map is completely portable and can be used either in hard copy or in on-line or electronic versions. Their simplicity is compatible with repeated use in both individual and group settings.

In one aspect of an alternate embodiment of the invention the Patient Journey Map discloses a tool that: i) makes it easy to collect information about the patient in a holistic manner that tells the story of the weight challenges; ii) creates a visual depiction of the patient's journey; iii) makes the patient feel comfortable in revealing personal information; iv) allows the clinician to develop an understanding of the many factors that contribute to an individual's weight issues and develop a comprehensive treatment plan that will have a high likelihood of success; v) identifies patients who are “at risk” for certain medical co-morbidities or psychological problems for whom early interventions would be appropriate; vi) allows the ability to aggregate data from multiple Patient Journey Maps to allow researchers and industry to segment patients; vii) allows for repeated use of the tool over time to assess the patient's progress; and viii) can be used in conjunction with an Obesity Health Risk Indicator.

With specific reference to FIG. 8, The Beginning is a place for the patient to articulate their perception of how and when their weight became an issue. By understanding these drivers, clinicians may be better able to recommend treatment plans.

The Round-a-Bout reflects the well-documented cycle of failed weight loss attempts. By understanding the causes of failure, clinicians and patients may be better able to prevent these failures in future weight management attempts.

For individuals who have gained control of their weight, The Bridge represents the event or situation that triggered their success at gaining control.

For those individuals who have not yet gained control of their weight, the Horizon represents a place where the patient can describe what successful weight control would feel like. By understanding these expectations, the patient and clinician can tailor treatments and can establish a set of realistic expectations. For those individuals who have gained control, the Horizon represents a place for them to reflect on what they have accomplished and how it feels. This is an important tool that can be used to provide encouragement to the patient over time.

The River is an area where the patient can articulate the obstacles that they are encountering that hold them back from successful control of their weight.

The Clouds is an area where the patient can articulate what worries and concerns them at the present time.

One method of use of the Journey Map instructs a patient to “complete” the Journey Map in any way that feels most appropriate to them. This can be done individually or in a group setting. The patient can use write text, draw pictures, and attach photographs or other images to the Journey Map. After it is complete, the patient is asked to tell the story of their journey to a clinician, market researcher, support group, etc. . . .

Discussions should follow so that both the patient and clinician understand what is being communicated. If appropriate, following the presentation of the journey map, the patient and clinician may discuss a treatment program tailored to the unique needs of the individual.

While the present invention has been illustrated by description of several embodiments, it is not the intention of the applicant to restrict or limit the spirit and scope of the appended claims to such detail. Numerous variations, changes, and substitutions will occur to those skilled in the art without departing from the scope of the invention. Moreover, the structure of each element associated with the present invention can be alternatively described as a means for providing the function performed by the element. Accordingly, it is intended that the invention be limited only by the spirit and scope of the appended claims.

We claim:

1. A method for assessing health risks of an individual comprising the steps of:
a) obtaining at least one health data input for the individual;
b) accessing a memory device that stores a health risk assessment database reflecting parameters of at least one individual health data;
c) performing an automated assessment of the individual's at least one health data;
d) assessing the risk of a disease of the individual; and
e) reporting the risk of a disease to the individual in accordance with the health risk assessment data.

2. The method of claim 1 further comprising a method of facilitating access to health care of the individual comprising the steps of:
f) accessing a memory device that stores a health care provider database;
g) performing an automated comparison of the risk of a disease of the individual and the health care provider data base; and
h) reporting a list of health care providers to the individual in accordance with the comparison of step b).

3. The method of claim 2 further comprising the steps of:
i) accessing a database that stores a health care provider scheduling database;
j) scheduling an appointment for the individual with at least one health care provider in accordance with the list of health care providers and the scheduling database.
